(19) United States
(12) Patent Application Publication
(10) Pub. No.: US 2015/0344770 A1
(43) Pub. Date: Dec. 3, 2015

(54) SYSTEM AND METHOD FOR PRODUCING CARBON DIOXIDE FOR USE IN HYDROCARBON RECOVERY

(71) Applicant: Michael J. LEWIS, Houston, TX (US)

(72) Inventor: Michael J. LEWIS, Houston, TX (US)

(21) Appl. No.: 14/742,974

(22) Filed: Jun. 18, 2015

Related U.S. Application Data
(63) Continuation of application No. 13/921,411, filed on Jun. 19, 2013.
Application No. 13/921,411 is a continuation-in-part of application No. 13/204,952, filed on Aug. 8, 2011, now abandoned.

(51) Int. Cl. C09K 8/594; B01D 53/62; F01D 15/10; B01D 53/78; E21B 43/16; F02C 1/00

(52) U.S. Cl. CPC C09K 8/594; E21B 43/164; F02C 1/002; F01D 15/10; B01D 53/78; B01D 53/62; F05D 2220/32; F05D 2210/12; B01D 2252/204

(57) ABSTRACT

A method for producing carbon dioxide for use in hydrocarbon recovery has the steps of producing an exhaust stream from a combustion turbine, passing the exhaust stream through a heat recovery steam generator so as to produce a carbon dioxide-laden stream and a steam, absorbing the carbon dioxide from the carbon-dioxide laden stream into a solution, pumping the solution to a stripper so as to produce carbon dioxide gas, compressing the carbon dioxide gas from the stripper, and injecting the compressed carbon dioxide gas into a hydrocarbon-bearing formation. The combustion turbine and the heat recovery steam generator are portable.

### CROSS-REFERENCE TO RELATED APPLICATIONS

The present application is a continuation-in-part of U.S. patent application Ser. No. 13/921,411, filed on Jun. 19, 2013, and entitled “Process for Enhanced Oil Recovery Using Capture of Carbon Dioxide”, presently pending. U.S. patent application Ser. No. 13/921,411 is a continuation-in-part of U.S. patent application Ser. No. 13/204,952, filed on Aug. 8, 2011, and entitled “System and Method for Producing Carbon Dioxide for Use in Hydrocarbon Recovery”, presently pending.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to carbon dioxide injection for tertiary hydrocarbon recovery. More particularly, the present invention the relates to portable carbon dioxide generators that can be used for producing the carbon dioxide gas for injection into a hydrocarbon-bearing formation. The present invention also relates to systems and methods whereby the carbon dioxide gas can be produced from the exhaust of a combustion turbine.

2. Description of Related Art Including Information Disclosed Under 37 CFR 1.97 and 37 CFR 1.98.

The world's power demands are expected to rise 50% by 2030. With worldwide total of active coal plants over 50,000 and rising, the International Energy Agency estimates that fossil fuels will account for 85% of the energy market by 2030. Meanwhile, trillions of dollars worth of oil remain underground in apparently depleted wells.

The U.S. currently produces approximately 5.1 million barrels of oil per day. Most of the oil fields in the United States are declining in oil recovery productivity. It has been proven that carbon dioxide can be used for enhanced oil recovery so as to increase oil recovery productivity in the declining fields. The Department of Energy estimates that 89 billion barrels of “stranded” oil can be recovered using carbon dioxide for enhanced oil recovery.

There are tens of thousands of depleted oil and natural gas wells around the world, which collectively possess significant amounts of petroleum resources that cannot currently be extracted using conventional extraction techniques. For example, in a typical oil well, only about 30% of the underground oil is recovered during initial drilling. An additional approximately 20% may be accessed by “secondary recovery” techniques such as water flooding. In recent years, “tertiary recovery” techniques have been developed to recover additional oil from depleted wells. Such tertiary recovery techniques include thermal recovery, chemical injection, and gas injection. Using current methods, these tertiary techniques allow for an additional 20% or more of the original oil-in-place (OOIP) to be recovered.

Gas injection is one of the most common tertiary techniques. In particular, carbon dioxide injection into depleted oil wells has received considerable attention owing to its ability to mix with crude oil. Since the crude oil is miscible with carbon dioxide, the injection of carbon dioxide renders the oil substantially less viscous and more readily extractable.

Carbon dioxide in quantities sufficiently large enough for commercial exploitation generally has come from three sources. One such source is the naturally occurring underground supply of carbon dioxide in areas such as Colorado, Wyoming, Mississippi, and other areas. A second source is that resulting from by-products of the operation of a primary process, such as the manufacture of ammonia or a hydrogen reformer. A third source is found in the exhaust gases from burning of various hydrocarbon fuels. One of the largest problems that is faced by carbon dioxide users is the problem of transportation from the place of production to the point of use.

Problems exist within the current carbon dioxide pipeline infrastructure in that extensions into potentially productive areas are costly and somewhat limited due to the availability of high purity carbon dioxide. Even in areas that have relatively close proximity to an existing carbon dioxide pipeline, extensions to potential producing areas are costly and time-consuming. The single greatest problem is the lack of commercial quantities of carbon dioxide in close proximity to the oil fields that are in need of this resource to produce the remaining the reserves that are recoverable by using the tertiary recovery methods. This problem is exacerbated when the field is remote to an existing carbon dioxide pipeline and/or is not of sufficient size to justify the costly extension of the pipeline infrastructure. Because an oilfield undergoing tertiary recovery will begin to recycle quantities of carbon dioxide that is recovered along with the tertiary oil, the need for carbon dioxide will diminish significantly over time. This necessitates the recovery of pipeline infrastructure capital costs quickly.

Currently, carbon dioxide is present in low concentrations, such as within the flue gas from power generation facilities. These plants are found all over the United States and can be fired from a variety of hydrocarbon sources, including coal, fuel oil, biomass, and natural gas. Unfortunately, these facilities are most often located near large water sources due to their need to use this water for cooling during the power production process. In addition, generally, these are very large facilities with a long economic life. There are many oil fields that are not located within sufficiently close proximity to attempt to economically utilize a carbon capture technology and pipeline delivery method to provide the carbon dioxide to the oilfields that have this need.

In the past, various patents have issued relating to the production of carbon dioxide for tertiary hydrocarbon recovery. For example, U.S. Pat. No. 4,499,946, issued on Feb. 19, 1985 to Martin et al., provides a portable, above-ground system and process for generating combustion gases and for injecting the purified nitrogen and carbon dioxide at controlled temperatures into a subterranean formation so as to enhance the recovery thereof. The system includes a high-pressure combustion reactor for sufficient generation of combustion gases at the required rates and at pressures up to about 8000 p.s.i. and temperatures up to about 4500° F. The reactor is water-jacketed but lined with refractory material to minimize soot formation.

U.S. Pat. No. 4,741,398, issued on May 3, 1988 to F. L. Goldsberry, shows a hydraulic accumulator-compressor vessel using geothermal brine under pressure as a piston to compress carbon dioxide-rich gas. This is used in a system having a plurality of gas separators in tandem to recover pipeline quality gas from geothermal brine. A first high pressure separator feeds gas to a membrane separator which separates low pressure waste gas from high pressure quality gas. A second separator produces low pressure waste gas. Waste gas from both separators is combined and fed into the vessel through a port at the top as the vessel is drained for another compression cycle.

U.S. Pat. No. 4,824,447, issued on Apr. 25, 1989 to F. L. Goldsberry, describes an enhanced oil recovery system which produces pipeline quality gas by using a high pressure separator/heat exchanger and a membrane separator. Waste gas is recovered from both the membrane separator and a low pressure separator in tandem with the high pressure separator. Liquid hydrocarbons are skimmed off the top of geothermal brine in the low pressure separator. High pressure brine from the geothermal well is used to drive a turbine/generator set before recovering waste gas in the first separator. Another turbine/generator set is provided in a supercritical binary power plant that uses propane as a working fluid in a closed cycle and uses exhaust heat from the combustion engine and geothermal energy of the brine in the separator/heat exchanger to heat the propane.

U.S. Pat. No. 4,899,544, issued on Feb. 13, 1990 to R. T. Boyd, discloses a cogeneration/carbon dioxide production process and plant. This system includes an internal combustion engine that drives an electrical generator. A waste heat recovery unit is provided through which hot exhaust gases from the engine are passed to recover thermal energy in a usable form. A means is provided for conveying exhaust gases coming out of the waste heat recovery unit to a recovery unit where the carbon dioxide is extracted and made available as a saleable byproduct.

U.S. Pat. No. 7,753,972, issued on Jul. 13, 2010 to Zubrin et al., discloses a portable renewable energy system for enhanced oil recovery. This is a truck mobile system that reforms biomass into carbon dioxide and hydrogen. The gases are separated. The carbon dioxide is sequestered underground for enhanced oil recovery and the hydrogen used to generate several megawatts of carbon-free electricity.

U.S. Patent Publication No. 2008/0283247, published on Nov. 20, 2008 to Zubrin et al., shows a portable, modular apparatus for recovering oil from an oil well and generating electric power. This system includes a chassis to support a fuel reformer, a gas separator, a power generator, and/or a compressor. The fuel reformer module is adapted to react a fuel source with water to generate a driver gas including a mixture of carbon dioxide gas and hydrogen gas. The gas separator module is operatively coupled to the reformer module and is adapted to separate at least a portion of the hydrogen gas from the rest of the driver gas. The power generator module is operatively coupled to the gas separator module and is adapted to generate electric power using a portion of the separated hydrogen gas. The compressor module is operatively connected to the reformer module and is adapted to compress a portion of the driver gas and to eject the driver gas at high pressure into the oil well for enhanced oil recovery.

U.S. Patent Publication No. 2009/0236093, published on Sep. 24, 2009 to Zubrin et al., shows a method for extracting petroleum by using reformed gases. This method includes reforming a fuel source by reaction with water to generate driver gas and injecting the driver gas into the oil well. The reforming operation includes causing the combustion of a combustible material with ambient oxygen for the release of energy. A reforming reaction fuel and water is heated with the energy released from this heating process. This is at a temperature above that required for the reforming reaction in which the fuel and water sources are reformed into driver gas.

U.S. Patent Publication No. 2010/0314136, published on Dec. 16, 2010 to Zubrin et al., discloses an in-situ apparatus for generating carbon dioxide gas at an oil site for use in enhanced oil recovery. The apparatus includes a steam generator adapted to boil and superheat water to generate a source of superheated steam, as well as a source of essentially pure oxygen. The apparatus also includes a steam reformer adapted to react a carbonaceous material with the superheated steam and the pure oxygen, in an absence of air, to generate a driver gas made up of primarily carbon dioxide gas and hydrogen. A separator is adapted to separate at least a portion of the carbon dioxide gas from the rest of the driver gas to generate a carbon dioxide-rich driver gas and a hydrogen-rich fuel gas. A compressor is used for compressing the carbon dioxide-rich driver gas for use in enhanced oil recovery.

U.S. Patent Publication No. 2011/0067410, published on Mar. 24, 2011 to Zubrin et al., teaches a reformation power plant that generates clean electricity from carbonaceous material and high pressure carbon dioxide. The reformation power plant utilizes a reformation process that reforms carbonaceous fuel with super-heated steam into a high-pressure gaseous mixture that is rich in carbon dioxide and hydrogen. This high-pressure gas exchanges excess heat with the incoming steam from a boiler and continues onward to a condenser. Once cooled, the high-pressure gas goes through a methanol separator, after which the carbon dioxide-rich gas is sequestered underground or is re-used. The remaining hydrogen-rich gas is combusted through a gas turbine. The gas turbine provides power to a generator and also regenerative heat for the boiler. The generator converts mechanical energy into electricity, which is transferred to the electric grid.

It is an object of the present invention to provide a system for use in hydrocarbon recovery that places a high purity carbon dioxide source close to the hydrocarbon-bearing formation.

It is another object of the present invention to provide a system for producing carbon dioxide and hydrocarbon recovery which is portable.

It is still another object of the present invention to provide a system for producing carbon dioxide for use in hydrocarbon recovery that can be permitted as a minor emission source.

It is still a further object of the present invention to provide a system for producing carbon dioxide for use in hydrocarbon recovery which can be delivered in short order to a desired location.

It is a further object of the present invention to provide a system for producing carbon dioxide for use in hydrocarbon recovery which allows power to be sold into the power grid.

It is still another object of the present invention to provide a system for producing carbon dioxide for use in hydrocarbon recovery that is environmentally beneficial.

It is still a further object of the present invention to provide a system for producing carbon dioxide for use in hydrocarbon recovery which minimizes site work and field construction costs and equipment.

These and other objects and advantages of the present invention will become apparent from a reading of the attached specification and appended claims.

### BRIEF SUMMARY OF THE INVENTION

The present invention is a method for producing carbon dioxide for use in hydrocarbon recovery. The method includes the steps of: (1) producing an exhaust stream from a combustion turbine; (2) passing the exhaust stream through a heat recovery steam generator so as to produce a carbon dioxide-laden stream and a steam; (3) absorbing the carbon dioxide from the carbon-dioxide laden stream into a solution: (4) pumping the solution to a stripper so as to produce carbon dioxide gas; (5) compressing the carbon dioxide gas from the stripper; and (6) injecting the compressed carbon dioxide gas into a hydrocarbon-bearing formation.

In the method of the present invention, the steam is passed from the heat recovery steam generator to the stripper so as to heat the solution in the stripper to a temperature in which the carbon dioxide gas is released from the solution. The heat recovery steam generator causes the carbon dioxide-laden stream to have a temperature less than the exhaust stream. A portion of the steam from the heat recovery steam generator is used in an absorption chiller. The absorption chiller produces refrigeration that is used, in part, cool the inlet air stream going into the combustion turbine and, as a result, increases the efficiency of the turbine. The refrigeration can also be used, in part, to cool the amine solution so as to allow for more efficient carbon dioxide absorption.

The combustion turbine is connected to a power grid. The combustion turbine generates power. This power can be delivered from the combustion turbine to the power grid.

In the present invention, the combustion turbine and the heat recovery steam generator can be moved to a desired location adjacent to the hydrocarbon-bearing formation. The carbon dioxide is absorbed into the solution in an amine contactor. The stripper is an amine reboiler.

The present invention is also a system for producing carbon dioxide for use in hydrocarbon recovery. This system has a combustion turbine suitable for generating electricity and a hot exhaust. A heat recovery steam generator is connected to the combustion turbine so as to receive the hot exhaust therefrom. The heat recovery steam generator produces steam and a carbon dioxide-laden exhaust. An amine contactor is connected to the heat recovery steam generator so as to receive the carbon dioxide-laden exhaust. The amine contactor is suitable for absorbing the carbon dioxide from the carbon dioxide-laden exhaust into a solution. An amine reboiler is connected to the amine contactor so as to receive the solution therefrom. The amine reboiler is suitable for stripping carbon dioxide gas from the solution. A carbon dioxide compressor is connected to the amine reboiler so as to receive the carbon dioxide gas therefrom. The carbon dioxide compressor is suitable for compressing the carbon dioxide gas from a pressure sufficient for injection into a hydrocarbon-bearing formation.

The combustion turbine, the heat recovery steam generator, the absorption chiller, the amine contactor and the amine reboiler are portable. The heat recovery steam generator is connected the amine reboiler so as to pass steam therefrom to the amine reboiler. The amine contactor is connected by a first line and a second line to the amine reboiler. The first line is suitable for passing the carbon dioxide-contacting solution from the amine contactor to the amine reboiler. The second line is suitable for passing carbon dioxide-removed solution from the amine reboiler to the amine contactor.

An absorption chiller is connected to the heat recovery steam generator so as to receive the steam therefrom. The absorption chiller is connected to the combustion turbine so as to cool air passing into the combustion turbine and to the amine solution for cooling the amine stream.

An electricity grid is connected to the combustion turbine so as to receive the electricity therefrom. The carbon dioxide compressor is driven by an electric motor. The combustion turbine is electrically connected to the electric motor of the carbon dioxide compressor so as to supply electricity thereto.

### BRIEF DESCRIPTION OF THE SEVERAL VIEWS OF THE DRAWINGS

FIG. 1 is a block diagram showing the system and method for producing carbon dioxide for use in hydrocarbon recovery in accordance with the preferred embodiment of the present invention.

### DETAILED DESCRIPTION OF THE INVENTION

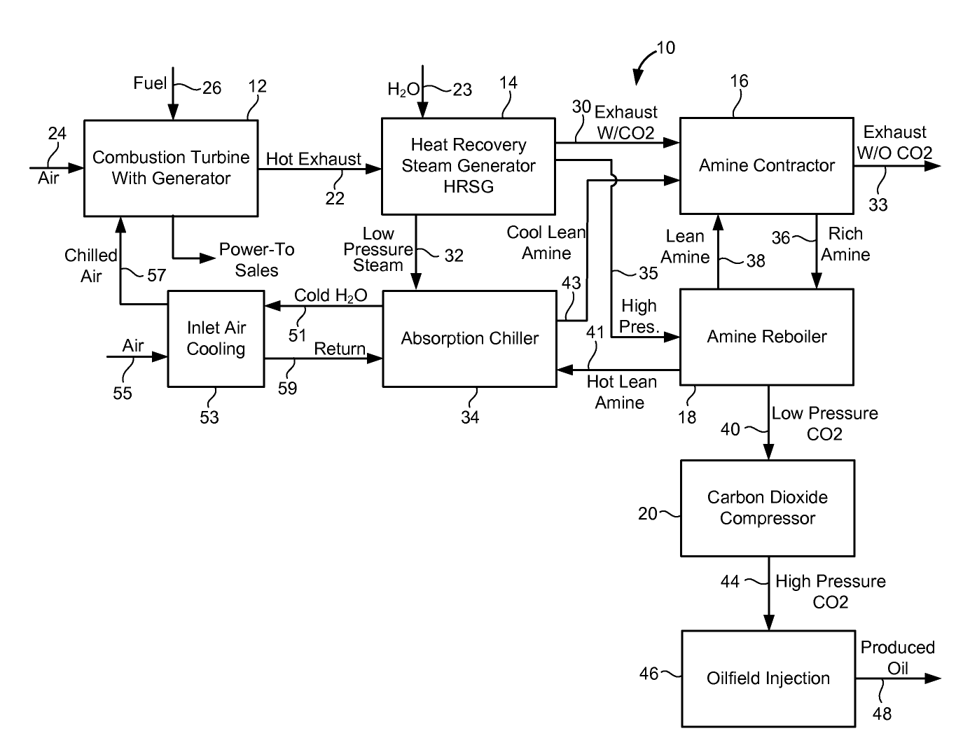

Referring to FIG. 1, there is shown the system 10 of the present invention for producing carbon dioxide for the use in hydrocarbon recovery. The system of the present invention includes a combustion turbine 12, a heat recovery steam generator 14, an amine contactor 16, an absorption chiller, an amine reboiler 18 and a carbon dioxide compressor 20.

The combustion turbine 12 is a conventional combustion turbine which can produce a hot exhaust 22. The combustion turbine operates by receiving air 24 and fuel 26. The combustion turbine 12 includes a generator suitable for generating electrical energy. The generator is connected by line 28 to an electrical grid. As such, the electrical energy produced by the combustion turbine can be connected to the electrical grid so that electrical energy from the generator can be sold to the utility. The combustion turbine 12 is attached to a high voltage electric generator and will use an aero-derivative combustion turbine for weight and portability purposes. The hot exhaust 22 from the combustion turbine 12 is then passed to the heat recovery steam generator 14.

The heat recovery steam generator 14 causes the hot exhaust 22 from the combustion turbine 12 to pass therethrough such that the heat recovery steam generator 14 will extract residual heat from the hot exhaust 22 and produce steam while, at the same time, lowering the exhaust temperature before the exhaust gases pass into the amine contactor 16 or other carbon dioxide capture systems. The water is introduced to the heat recovery steam generator 14 along line 23. The water passing through water line 23 provides the source for the steam from the heat recovery steam generator 14. In particular, within the concept of the present invention, the water flowing through line 23 can be brackish water that is processed to fresh water through a reverse osmosis system. This treated water can then pass through a heat exchanger with the oil that comes from the oilfield inlet separator. As such, when the produced oil is relatively hot, prior to being placed into a pipeline, the water passing through line 23 can be pre-heated prior to passing to the heat recovery steam generator 14. As such, the water will serve to cool down the oil. The exhaust, along with carbon dioxide-laden gas, will pass through line 30 to the amine contactor 16. The high-pressure steam from the heat recovery steam generator 14 passes outwardly along line 35 to the amine reboiler 18.

The carbon dioxide-laden exhaust gas passing through line 30 is delivered to the amine contactor 16. This is a low-pressure contactor vessel where the low concentration carbon dioxide is absorbed into a solution which reacts with the carbon dioxide. As such, the carbon dioxide-free exhaust passes outwardly of the amine contactor 16 along line 33.

The amine contactor 16 is connected to the amine reboiler 18 by a first line 36 and a second line 38. The solution containing the concentrated carbon dioxide and rich amine is pumped into the amine reboiler 18 through line 36. The steam from the heat recovery steam generator 14 is delivered along line 35 as heat to the amine reboiler 18. As such, this heat is used so as to strip the carbon dioxide from the solution. As a result, the low pressure carbon dioxide will pass outwardly of the amine reboiler 18 through line 40 to the carbon dioxide compressor 20. The lean amine solution from the amine reboiler 18 is delivered back to the amine contactor 16 along line 38. The carbon dioxide that passes through line 40 is a low-pressure, high-purity carbon dioxide. The hot lean amine is delivered along line 41 to the absorption chiller 34. The hot lean amine is the material remaining after the carbon dioxide is boiled off in the amine reboiler 18. The hot lean amine will go to the absorption chiller 34 for cooling before being pumped up into the amine contactor 16 along line 43.

A portion of the low-pressure steam that is produced by the heat recovery steam generator 14 will also be used to provide the energy to the absorption chiller 34 through line 32. This is utilized for cooling the amine solution and the inlet air to the combustion turbine 12. The cold water from the absorption chiller 34 is delivered along line 51 to an inlet air chiller 53. The inlet air chiller 53 receives air through an inlet 55. The chilled air from the inlet air chiller 53 is delivered along pipe 57 to the combustion turbine 12. The warmed water will exit the inlet air chiller 53 through line 59 back for further cooling in the absorption chiller. The chilled air passing along pipe 57 to the combustion turbine will maximize the output of the turbine 12. The low pressure, high purity carbon dioxide passing along line 40 from the amine reboiler 18 is taken to the inlet of the multi-stage carbon dioxide compressor 20. The carbon dioxide compressor 20 utilizes an electrical motor. The power to this electrical motor can be driven by the output of the turbine generator 12. As such, the compressor 20 will compress the carbon dioxide up to the required field miscibility pressure. Ultimately, high-pressure carbon dioxide will pass through line 44 for injection into the hydrocarbon-bearing formation 46. The produced hydrocarbons will pass outwardly of the formation 46 along line 48.

As used herein, the absorption chiller 34 will produce cold water. The inlet air chiller 53 is a giant heat exchanger to which ambient air is passed and cooled before being delivered to the combustion turbine through line 56.

The present invention remedies the shortcomings of the prior art by placing a high purity carbon dioxide source close to the need, i.e. a target oil field. This high purity source utilizes a lower concentration carbon dioxide resource that is available through the combustion of a hydrocarbon or a biomass resources. The combustion produces the large quantities of heat that are necessary, by using current technology, for the process used to produce carbon dioxide from low concentration flue gas streams. As such, commercial quantities of high-purity carbon dioxide can be produced from portable facilities. These portable facilities can be installed, as needed, near oil fields that have this requirement. These portable facilities can then be relocated to another oil field whenever the need for additional quantities of carbon dioxide is diminished.

Through the utilization of the system 10 of the present invention and, because of the capture of the carbon dioxide and the use of a proven low-emission combustion turbine, the installation will be able to permitted as a minor emission source under current regulations. By doing this whenever a field is prepared for the acceptance of the carbon dioxide, the carbon dioxide production and capture system can be installed in short order.

When carbon dioxide is utilized for an enhanced oil recovery miscible carbon dioxide flood, once the field reaches the recycle stage where a portion of the injected carbon dioxide returns with the produced oil and is separated for rejection, the need for additional newly produced carbon dioxide will decrease. In an instance such as this, and because it is anticipated that several different capacity carbon dioxide production units will be manufactured, a larger production facility can be removed to replace with a more appropriately-sized facility.

An important issue facing the world today is that of climate change. One of the major greenhouse gases is carbon dioxide. The power generation industry is one of the major sources of carbon dioxide emission because of the combustion of carbon-based fuels. The system of the present invention produces power that can be sold into the power grid. It can also be used to generate the power necessary to displace a portion of the power currently required from carbon-based fuel. Current capture technologies allow for the capture of in excess of 90% of the carbon dioxide produced during combustion. This carbon dioxide is utilized in a miscible oil field flood so as to ensure that the carbon dioxide remains in the oil reservoir.

Oil field floods with carbon dioxide are accepted as being one of the most efficient methods of producing additional hydrocarbons which would otherwise be stranded. While methods of reservoir modeling are very advanced, there is a possibility that the results will not be financially acceptable. Irregularities in the formation structure, such as impermeable zones, may lead to far lower recovery rates and the resultant need for much less carbon dioxide. If a permanent facility, such as a lengthy high-cost pipeline or a stationary recovery plant, is required, many potential oilfields will never be recipients of carbon dioxide due to the high cost of getting initial carbon dioxide volumes for the field. The present invention resolves this issue because the system 10 of present invention is portable. The component parts can be trailer or skid-mounted. This will minimize site work and field construction. Field construction cost will also be minimized. The equipment used can be reusable. As such, at the time that the quantities of carbon dioxide are no longer required, the system can be disassembled and moved to another potential location.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A method for producing carbon dioxide for use in hydrocarbon recovery, the method comprising:
transporting a carbon-dioxide producing system to a location adjacent a hydrocarbon-bearing formation, said carbon-dioxide producing system including a combustion turbine, a heat recover steam generator, a stripper and an absorption chiller;
producing an exhaust stream from said combustion turbine;
passing the exhaust stream through said heat recovery steam generator so as to produce a carbon-dioxide laden stream and a steam;
absorbing the carbon dioxide from the carbon-dioxide laden stream into a solution;
pumping the solution to said stripper so as to produce carbon dioxide gas;
compressing the carbon dioxide gas from said stripper;
injecting the compressed carbon dioxide gas into the hydrocarbon-bearing formation;
passing the steam from said heat recovery steam generator to said absorption chiller;
passing air through said absorption chiller so as to cool the air therein; and
delivering the cooled air from said absorption chiller as inlet air to said combustion turbine.

2. The method of claim 1, further comprising:
passing the steam from the heat recovery steam generator to said stripper so as to heat the solution in said stripper to a temperature in which the carbon dioxide gas is released from the solution.

3. The method of claim 1, said heat recovery steam generator causing and carbon dioxide-laden stream to have a temperature less than said exhaust stream.

4. The method of claim 1, further comprising:
connecting said combustion turbine to a power grid;
generating power by said combustion turbine; and
delivering the power from said combustion turbine to said power grid.

5. The method of claim 1, the carbon dioxide being absorbed into the solution in an amine contactor, said stripper being an amine reboiler.

6. A system for producing carbon dioxide for use in hydrocarbon recovery, the system comprising:
a combustion turbine suitable for generating electricity and a hot exhaust;
a heat recovery steam generator connected to said combustion turbine so as to receive the hot exhaust therefrom, said heat recovery steam generator producing steam and a carbon dioxide-laden exhaust;
an amine contactor connected to said heat recovery steam generator so as to receive the carbon dioxide-laden exhaust, said amine contactor suitable for absorbing the carbon dioxide from the carbon dioxide-laden exhaust into a solution;
an amine reboiler connected to said amine contactor so as to receive the solution therefrom, said amine reboiler suitable for stripping carbon dioxide gas from the solution;
a carbon dioxide compressor connected to said amine reboiler so as to receive the carbon dioxide gas therefrom, said carbon dioxide compressor suitable for compressing the carbon dioxide gas to a pressure sufficient for injection into a hydrocarbon-bearing formation; and
an absorption chiller connected to said heat recovery steam generator so as to receive the steam therefrom, said absorption chiller connected to said combustion turbine so as to cool air passing into said combustion turbine, said combustion turbine and said heat recovery steam generator and said amine contactor and said amine reboiler being portable.

7. The system of claim 6, said heat recovery steam generator being connected said amine reboiler so as to pass steam therefrom to said amine reboiler.

8. The system of claim 6, said amine contactor being connected by a first line and a second line to said amine reboiler, said first line suitable for passing the carbon dioxide-contacting solution from said amine contactor to said amine reboiler, said second line suitable for passing carbon dioxide-removed solution from said amine reboiler to said amine contactor.

9. The system of claim 6, further comprising:
an electricity grid connected to said combustion turbine so as to receive the electricity therefrom.

10. The system of claim 6, said carbon dioxide compressor being driven by an electric motor, said combustion turbine electrically connected to said electric motor of said carbon dioxide compressor so as to supply electricity thereto.

11. The system of claim 6, said amine contactor having an exhaust line extending therefrom, said exhaust line for passing carbon dioxide-free gas therefrom.
